(19) United States
(12) Patent Application Publication
(10) Pub. No.: US 2007/0002347 A1
(43) Pub. Date: Jan. 4, 2007

(54) System and method for upgrading firmware in a display

(75) Inventors: Jing-Zhou Lai, Shenzhen (CN); Yan-Bo Yu, Shenzhen (CN); Liang-Yan Dai, Shenzhen (CN); Ming-Lei Niu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/479,521

(22) Filed: Jun. 30, 2006

(30) Foreign Application Priority Data
Jul. 2, 2005 (CN) 200510035781.9

(51) Int. Cl. G06F 3/12

(52) U.S. Cl. 358/1.9; 358/1.13

(57) ABSTRACT

A system and method for automatically upgrading the firmware of a display without user interaction, wherein a new version of firmware is downloaded and stored at a host computer. The host computer monitors all communications between the host computer and an external source to determine when new or updated firmware has been uploaded. If the host computer includes a graphic card, the display is checked to determine whether it is active. If the display is active, communication over a communication cable located between the host computer and display is established, and the new version of firmware is uploaded to memory located in the display. The host computer forwards the firmware over the communication cable as at least one signal component, such as data and clock signals, which is transmitted from a graphic card located in the host computer to a graphic processor located in the display.

### FIELD OF THE INVENTION

The present invention is directed to video displays and, more particularly, to a system and method for automatically upgrading firmware in a display without user intervention.

### GENERAL BACKGROUND

Firmware is programming that is inserted into a read-only memory (ROM), thus becoming a permanent part of a computing device. Firmware is created and tested like software (using microcode simulation). When ready, it can be distributed like other software and, using a special user interface, installed in the read-only memory by the user. Generally, an on-screen display (“OSD”) is built into a flat display panel, and is typically used to locally adjust various important parameters by users, such as brightness, color contrast, Gamma correction, Standard Red Green Blue (sRGB), monitor size and scaling factors. These parameters are can be adjusted by a user operating the push button control panel of the flat display panel. Firmware pre-installed in a printed circuit board of the flat display panel is used to regulate the above-mentioned parameters of the flat display panel. If more functions are added into the OSD of the flat display panel, then a newer version of the firmware is created, which is then provided to users of the OSD. In view of the availability of updated firmware, it is desirable for a user to upgrade firmware in a timely and convenient way to ensure that the display operates in an optimal manner based on the updated firmware.

FIG. 4 is a schematic block diagram of a conventional system for upgrading firmware of a liquid crystal display. As shown therein, a host computer 10 includes a print port 15, such as a parallel port or serial port. A flat panel display 40 includes a printed circuit board (PCB) 30 having a video signal connector 45. Also shown is a conversion module 35 which includes a power supply (not shown) and a signal box (not shown).

The print port 15 is connected to the conversion module 35 by a first connection cable 20, and the video signal connector 45 of the PCB 30 is connected to the conversion module 35 by a second connection cable 25. Here, the conversion module 35 is located externally from the host computer 10 and the flat panel display 40.

In the conventional system of FIG. 4, when the user wants to upgrade the firmware of the flat panel display 40, the pre-installed firmware in the host computer 10 is sent via the print port 15 through the first connection cable 20 to the conversion module 35. The firmware is then sent from the conversion module 35 through the second connection cable 25 to the PCB 30 of the flat panel display 40.

The data transfer among the print port 15, the conversion module 35 and the video signal connector 45 are in conformity with specification of I²C bus protocol, as specified by the Video Electronics Standards Association (VESA). Moreover, the print port 15 and the video signal connector 45 are compatible with the I²C bus protocol. However, a dedicated device and a dedicated bus is required to transfer and upgrade the firmware of the flat display panel 40, which is time-consuming, slow and cumbersome for use in upgrading the firmware of the display.

Accordingly, there is a need for a system and method for permitting the rapid transfer and upgrade of the firmware of a display.

### SUMMARY

The present invention is directed to a system and method for automatically upgrading the firmware of a display without user interaction. In accordance with the present invention, a new version of firmware is downloaded from an external source, and stored at a host computer. The host computer monitors all communications between the host computer and the external device to determine when new or updated firmware has been uploaded. If a graphic card is installed on the motherboard of the host computer, then a check is performed to determine whether the display is active. In accordance with the present invention, the host computer sends a “polling” signal through an output port of the graphic card located in the host computer to determine whether the display is active.

If the display is active, communication is established between the graphic card of the host computer and a printed circuit board (PCB) of the display. In accordance with a communication protocol, data and clock signals are sent from the host computer through a communication cable, located between the graphic card and the PCB to the video signal connection port of the PCB of the display. Preferably, the display is a flat panel display, such as a liquid crystal display.

Next, the data signals and the clock signals sent from the host computer are sent from the video signal connection port to a graphic processing unit located in the display. At this point, the data signals and the clock signals are compiled into the firmware by the graphic processing unit. The firmware is then sent from the graphic processing unit to memory located on a printed circuit board that also contains the graphic processing unit. The firmware is then installed and upgraded at the memory located on the PCB of the display. In the preferred embodiment, the memory is flash memory, such as random access memory (RAM), programmable read-only memory (PROM) or electrically erasable PROM (E²PROM). However, the memory is not limited to these exemplary memory devices.

Other objects and features of the present invention will become apparent from the following detailed description considered in conjunction with the accompanying drawings. It is to be understood, however, that the drawings are designed solely for purposes of illustration and not as a definition of the limits of the present invention, for which reference should be made to the appended claims. It should be further understood that the drawings are merely intended to conceptually illustrate the structures and procedures described herein.

### BRIEF DESCRIPTION OF THE DRAWINGS

The foregoing and other advantages and features of the present invention will become more apparent from the detailed description of the exemplary embodiments of the present invention given below with reference to the accompanying drawings in which:

FIG. 1 is a schematic block diagram of the system for upgrading firmware of a display in accordance with an embodiment of the present invention;

FIG. 2 is a schematic block diagram of a pin configuration of an output port of a connector of the system of FIG. 1 in accordance with the present invention;

FIG. 3 is flowchart illustrating the steps of the method of the present invention; and

FIG. 4 is a schematic block diagram of a conventional system for upgrading firmware of a display.

### DETAILED DESCRIPTION OF PREFERRED EMBODIMENTS

The present invention is a system and method for automatically upgrading the firmware of a display without user interaction. In accordance with the present invention, a new version of firmware is downloaded, such as the Internet or storage device, and stored at a host computer. Here, the host computer monitors all communications between the host computer and the external source to determine when new or updated firmware has been uploaded. If the host computer includes a graphic card, the display is checked to determine whether it is active. If the display is active, communication over a communication cable located between the host computer and the display is established, and the new version of firmware is uploaded to memory located in the display. The host computer forwards the firmware over the communication cable as at least one signal component, e.g., data signals and clock signals, which is transmitted from a graphic card located in the host computer to a graphic processor located in the display. In the preferred embodiment, the memory is a flash memory, such as a random access memory (RAM), a programmable read-only memory (PROM) or an electrically erasable PROM (E²PROM). However, the memory is not limited to these exemplary memory devices.

Referring to FIG. 1, shown therein is a schematic block diagram of a system in accordance with an embodiment of the present invention. As shown therein, the system includes a host computer 200, a graphic card 210, a display panel 220, a printed circuit board 222 and a communication cable 230. In the preferred embodiment, display 220 is a flat panel display, such as a liquid crystal display.

The graphic card 210 is electrically connected with the host computer 200, and is an internal component of the host computer 200. The graphic card 210 includes a register 215 to which the graphic card 210 is electrically connected. Preferably, the register 215 is a random access memory (RAM). However, a person skilled in the art would readily appreciate that the register 215 may be comprised of other types of memory, such as SDRAM or RDRAM. The graphic card 210 further includes an output port 217 that may comprise a D-sub or a Digital Visual Interface (DVI) connector. Naturally, a person skilled in the art would appreciate that the output port 217 is not necessarily limited to D-sub or DVI connectors.

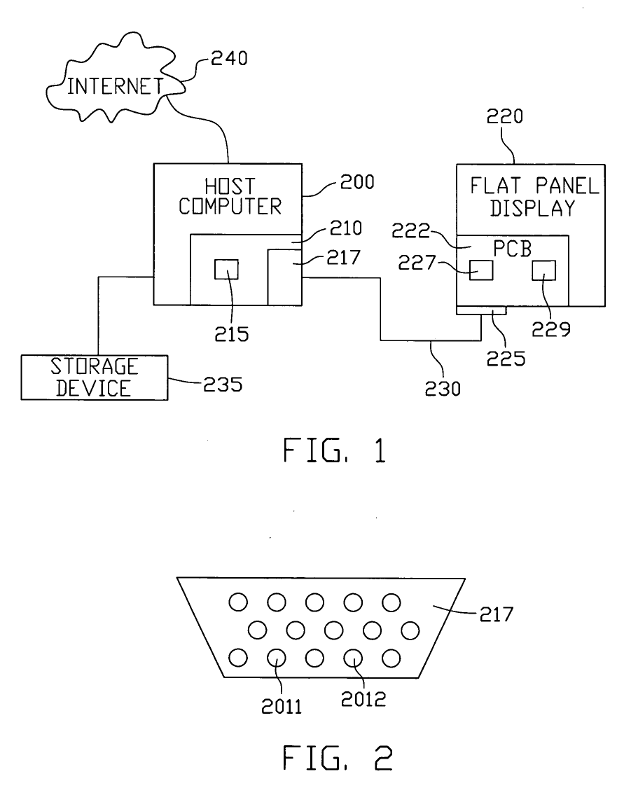

FIG. 2 is a schematic block diagram of a pin configuration of the output port 217 of FIG. 1. Preferably, the output port 217 is a D-sub connector, and pins 2012 and 2011 may be used to send data signals and clock signals from the host computer 200 to the display 220, respectively. The two ends of the communication cable 230 (FIG. 1) may be 15-pin D-sub connectors but are not necessarily limited to such pin assignments.

With additional reference to FIG. 1, the display 220 includes a printed circuit board (PCB) 222 having a video signal connection port 225, a graphic processing unit 227 and a memory 229. In accordance with contemplated embodiments of the present invention, the memory 229 may be a flash memory, such as a random access memory (RAM), a programmable read-only memory (PROM) or an electrically erasable PROM (E²PROM). However, the memory 229 is not limited to these exemplary memory devices.

The communication cable 230 has a pair of connectors electrically connected at respective ends to the output port 217 of the graphic card 210 and the video signal connection port 225 of the printed circuit board 222. The graphic processing unit 227 compiles the at least one signal component, e.g. the data signals and clock signals, sent from the register 215 of the graphic card 210, and the memory 229 is used to install firmware after the graphic processing unit 227 compiles the at least one signal component.

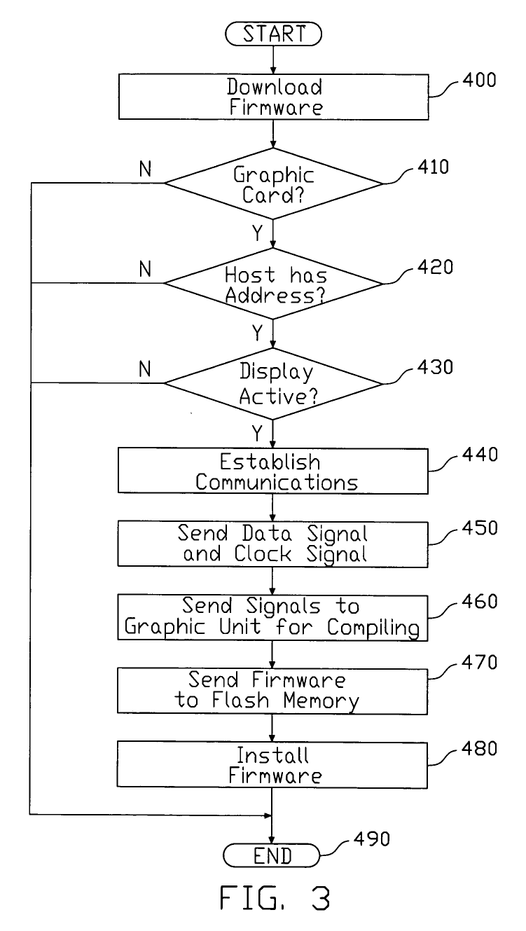

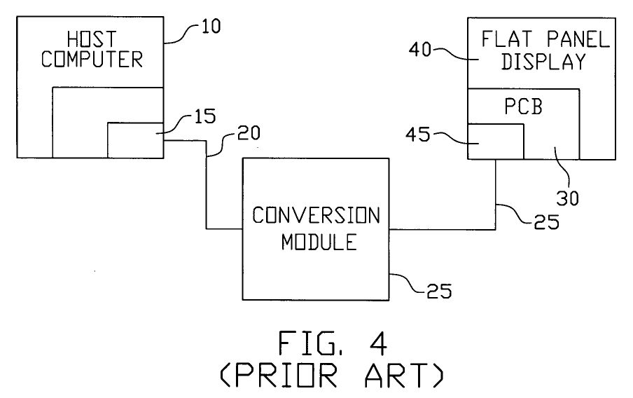

FIG. 3 are flowcharts illustrating the steps of the method for installing and upgrading firmware of a display panel having a printed circuit board, wherein the host computer includes and is electrically connected to a graphic card. The method begins when a new version of firmware is downloaded from an external source, such as the Internet 240 or a storage device 235 (FIG. 1), and stored at the host computer 200, as indicated in step 400. Here, the host computer 200 monitors all communications between the host computer 200 and the external source to determine when new or updated firmware has been uploaded. A check is performed to detect whether any graphic cards are installed on a motherboard (not shown) of the host computer 200, as indicated in step 410. If a graphic card is not installed on the motherboard, then the method proceeds to step 490 where all processing is terminated.

If, on the other hand, the motherboard of the host computer 200 includes a graphic card 210, then a check is performed to determine whether the host computer 200 possesses the correct address of the processing card 210, as indicated in step 420. If the host computer 200 does not possess the correct address of the graphic card 210, then the method proceeds to step 490 where all processing is terminated.

In accordance with the present invention, the method is implemented in a Microsoft Windows environment. However, a person skilled in the art would appreciate that the method of the present invention can be implemented in other computing environments, such as Linux, MAC OS or the like. In the Windows computing environment, the host computer 200 uses the Input/Output address of the graphic card 210 and application program DeviceControl( ) to send a command to “enable” the Input/Output flag address of the register 215 of the graphic card 210. In addition, the host computer 200 converts the firmware into at least one signal component, e.g., data signals and clock signals. In accordance with the present invention, the host computer 200 can send the at least one signal component, for example, the data and the clock signals to the register 215 of the graphic card 210. When the method of the present invention is implemented in other contemplated computing environments, such as Linux, the appropriate command associated therewith would be utilized to enable the Input/Output flag address of the register 215 of the graphic card 210.

Next, the host computer 200 sends a “polling” signal through, for example, pin 2011 (see FIG. 2), of the output port 217 of the graphic card 210 to determine whether the display 220 is active, as indicated in step 430. Preferably, the display 220 is a flat panel display. However, the present invention contemplates that the method may be applied to other types of displays. Detailed information of the display 220 is also obtained via the polling signal, such as an application test reply. The application test reply may include several fields including destination address, source address, length of information, data/command, data/status and checksum. Then, the application test reply is read by the graphic card 210. If the data/status is included in the application test reply, then the display 220 is active and communication is established between the graphic card 210 of the host computer 200 and the printed circuit board 222 of the display 220, as indicated in step 440. If the data/status is not included in the application test reply, that is a null message, then the display is inactive and the method proceeds to step 490 where all processing is terminated.

Next, the at least one signal component, e.g., the data and clock signals, is sent from the host computer 200 through the communication cable 230 located between the graphic card 210 and the printed circuit board 222 to the video signal connection port 225 of the printed circuit board 222 in accordance with a communication protocol, as indicated in step 450. As stated previously, the host computer 200 contains the at least one signal component, e.g., the data signals and the clock signals, which may be sent to the output port 217 from the register 215. One example of the communication protocol used to send the at least one signal component is Display Data Channel communication protocol (e.g. DDC2Bi). However, any equivalent communication protocol may be used, and the present invention is not to be limited to the presently disclosed protocol.

Next, the at least one signal component, e.g., the data signals and clock signals, sent from the host computer 200 is sent through the video signal connection port 225 to the graphic processing unit 227, as indicated in step 460. At this point, the at least one signal component is compiled into the firmware by the graphic processing unit 227.

Next, the compiled firmware is sent from the graphic processing unit 227 to the memory 229, as indicated in step 470. The firmware is then installed and upgraded at the memory 229, as indicated in step 480. Upon installation and upgrading of the firmware, the method is terminated, as indicated in step 490. In contemplated embodiments of the present invention, the memory 229 may be a flash memory, such as a random access memory (RAM), a programmable read-only memory (PROM) or an electrically erasable PROM (E²PROM). However, the memory 229 is not limited to these exemplary memory devices.

The system and method of the present invention permits the advantageous rapid transfer and upgrade of firmware in a display without the use of an external conversion module. As a result, scalability is achieved, because multiple displays may be upgraded simultaneously or at any desired point in time. In addition, maintenance costs associated with upgrading multiple displays are reduced, because the requirement to individually upgrade displays one by one is eliminated.

Thus, while there have been shown and described and pointed out fundamental novel features of the present invention as applied to a preferred embodiment thereof, it will be understood that various omissions and substitutions and changes in the form and details of the devices described and illustrated, and in their operation, and of the methods described may be made by those skilled in the art without departing from the spirit of the present invention. For example, it is expressly intended that all combinations of those elements and/or method steps which perform substantially the same function in substantially the same way to achieve the same results are within the scope of the present invention. Substitutions of elements from one described embodiment to another are also fully intended and contemplated. It is the intention, therefore, to be limited only as indicated by the scope of the claims appended hereto.

What is claimed is:

1. A method for upgrading firmware of a display, comprising:
downloading firmware from an external data source to a host computer which generates at least one signal component based on the downloaded firmware;
determining whether a graphic card is installed on a mother board of the host computer and determining a configuration thereof if the graphic card is installed on the mother board of the host computer;
establishing communication between the graphic card of the host computer and the display based on a communication protocol and the configuration of the graphic card;
sending the at least one signal component from the host computer to the display using the communication protocol for processing by a graphic processing unit; and
sending the at least one signal component processed by the graphic processing unit to memory for installation in the display as upgraded firmware.

2. The method of claim 1, wherein the determining the configuration of the graphic card comprises the steps of:
determining whether the host computer possesses a correct address of the graphic card; and
sending a polling signal through an output port of the graphic card to determine whether the display is active if the host computer possesses the correct address of the graphic card.

3. The method of claim 1, wherein all processing is terminated if the graphic card is not installed on the mother board of the host computer.

4. The method of claim 2, wherein all processing is terminated if at least one of the host computer possesses an incorrect address of the graphic card and the display is inactive.

5. The method of claim 1, wherein the external data source comprises one of the Internet or a storage device.

6. The method of claim 1, wherein the at least one signal component comprises data signals and clock signals.

7. The method of claim 1, further comprising the step of: sending a command from the host computer to the graphic card to enable an Input/Output flag address of a register of the graphic card.

8. The method of claim 7, wherein the command is sent based on an Input/Output address of the graphic card and application program DeviceControl( ) command.

9. The method of claim 2, wherein the polling signal is sent through pin 2011 of the output port of the graphic card.

10. The method of claim 1, wherein the communication protocol is Display Data Channel

11. The method of claim 10, wherein the Display Data Channel comprises DDC2Bi.

12. The method of claim 1, wherein the at least one signal component is sent through a communication cable located between the graphic card and a printed circuit board of the host computer.

13. The method of claim 1, wherein the processing by the graphic processing unit comprises the step of compiling the at least one signal component into firmware.

14. The method of claim 13, wherein the at least one signal component comprises data and clock signals.

15. The method of claim 1, wherein the memory comprises flash memory.

16. The method of claim 15, wherein the flash memory comprises one of RAM, PROM or E²PROM.

17. The method of claim 1, wherein the display is a flat panel display.

18. The method of claim 17, wherein the flat panel display is a liquid crystal display.

19. A system for upgrading firmware of a display, comprising:
a host computer operatively coupled to an external source; said host computer including a graphic card having a register and an output port; said host computer generating at least one signal component based on firmware downloaded from the external source;
a communication cable operatively coupled to the host computer; said cable providing communication between the graphic card of the host computer and the display in accordance with a communication protocol, and said at least one signal component being sent from the graphic card of the host computer to the display in accordance with the communication protocol; and
a display including a printed circuit board having a graphic processing unit and flash memory; said graphic processing unit processing the at least one signal component sent from the graphic card of the host computer into firmware and sending the processed firmware to the flash memory for installation in the display as upgraded firmware.

20. The system of claim 19, wherein the external data source comprises one of the Internet or a storage device.
